(19) United States
(12) Patent Application Publication
(10) Pub. No.: US 2018/0361638 A1
(43) Pub. Date: Dec. 20, 2018

(54) ROTARY SHAFT TYPE TURNTABLE POSITIONING METHOD OF INJECTION MOLDING MACHINE

(71) Applicant: HWA CHIN MACHINERY FACTORY CO., LTD., TAINAN CITY (TW)

(72) Inventor: CHING KUN YANG, TAINAN CITY (TW)

(21) Appl. No.: 16/112,962

(22) Filed: Aug. 27, 2018

Related U.S. Application Data
(63) Continuation-in-part of application No. 14/945,773, filed on Nov. 19, 2015.

(51) Int. Cl. B29C 45/06; B29C 45/80; B29C 45/04

(52) U.S. Cl. CPC B29C 45/062; B29C 45/80; B29C 45/045; B29C 2945/76093; B29C 2945/76762; B29C 2945/76381; B29C 2945/76478; B29C 2945/76578; B29C 2945/76692; B29C 2945/76214

(57) ABSTRACT

A rotary-shaft type turntable positioning method of an injection molding machine is disclosed. A first encoder and a second encoder are installed at a driving shaft of a servomotor and a speed reducer respectively, so that after the injection molding machine finishes an injection molding, the driving shaft of the servomotor drives a transmission belt on an output shaft of the speed reducer to rotate a rotary shaft for the turntable to be rotated and positioned. During rotation, the first encoder and the second encoder sense a first rotation signal and a second rotation signal to adjust the position, so as to control the turntable to be rotated to a precise position.

### REFERENCE TO RELATED APPLICATION

This Application is being filed as a Continuation-in-Part Application of Ser. No. 14/945,773, filed 19 Nov. 2015, currently pending.

### FIELD OF THE INVENTION

The present invention relates to a positioning method, in particular a positioning method capable of controlling a rotary-shaft type turntable of an injection molding machine to be rotated to and positioned at a precise position.

### BACKGROUND OF THE INVENTION

Double color injection molding refers to a plastic injection molding of two or more colors, so that the manufactured products have the effects of two or more colors or materials. When a double color injection molding machine is operated, male and female molds are mounted on a mold plate that can be rotated reciprocally within 180 degrees. After the male and female molds are engaged, a first material feeding step is performed, and then the molds are opened, and the mold plate is rotated by 180 degrees to switch to a male mold position, and the male and female molds are engaged again before performing a second material feeding step, and finally the molds are opened and separate to finish the injection molding process and produce a product. The methods of rotating the conventional mold plate include a rotary-shaft method, a turntable-method, or a combination of the methods applied to the injection molding machine. As to the rotary-shaft method, an output shaft of the speed reducer is rotated by a belt which is looped round the gear of the rotary shaft, so that a mold fixed onto the rotary shaft can be rotated, and an encoder installed to a motor is provided for positioning the turntable. Although this method achieves the positioning effect, yet a backlash occurs easily when the reduction gear installed in the speed reducer is transmitted, and thus resulting in inaccurate positioning.

As disclosed in R.O.C. Pat. No. 498840 entitled “Improved mold turntable positioning structure of an injection molding machine”, two hydraulic shock absorbers are mounted to the top and bottom of the middle of the front wall of the injection molding machine by a positioning seat, and an impact plate is installed at the top of the middle of an outer wall of the turntable, so that the left sidewall of the impact plate abuts an operating end of the hydraulic shock absorber, and the turntable is driven by an hydraulic motor and a power shaft installed at a gear holder at the top of the wall of the injection molding machine to drive a driving gear, a driven gear, and a gear of the turntable to rotate sequentially and linked with the turntable for rotation, the impact plate rotates with the turntable synchronously, and when the right sidewall of the rotating impact plate abuts an operating end at the bottom of the hydraulic shock absorber, the rotating turntable eliminates the high-speed impact by the hydraulic shock absorber, so that the rotating impact plate is stopped and positioned instantly to reduce the time of the mold rotation cycle.

As disclosed in R.O.C. Pat. No. M497087 entitled “Double color injection molding machine with rotary shaft and turntable functions”, the machine comprises a turntable and a rotary shaft installed on the main body, and the turntable has a slot, and the main body has a rotary shaft sleeve, and the rotary shaft sleeve is passed into the turntable slot, and a first bearing corresponsive to the rotary shaft sleeve is installed in the slot and driven by a servomotor, so that when a mold is rotated by a rotary-shaft method, the servomotor drives a driving wheel to link a transmission belt, and the transmission belt drives a driven wheel of the rotary shaft sleeve. As a result, the rotary shaft sleeve and the rotary shaft are rotated simultaneously to achieve the positioning effect.

As disclosed in R.O.C. Pat. No. M476047 entitled “Injection molding machine turntable controlling device”, a servomotor is connected to a turntable mechanism, and a position recorder is provided for outputting position data of the turntable mechanism. After the servo driver receives the position data transmitted from the position recorder, electric power is supplied to drive the servomotor, and the servo driver knows the current position of the turntable mechanism according to the position data outputted by the position recorder to drive the servomotor to control the turntable mechanism to be moved to a target position precisely.

### SUMMARY OF THE INVENTION

In view of the drawbacks of the conventional method of rotating a rotary-shaft type mold plate that uses a servomotor and a speed reducer to drive the rotary shaft to be rotated and positioned, but the reduction gear of the speed reducer may produce a backlash to cause inaccurate positioning, the inventor of the present invention designed and developed a rotary-shaft type turntable of an injection molding machine in accordance with the present invention.

The present invention adds an encoder installed in the rotary-shaft type turntable positioning device, and uses at least two encoders to lower the error value of gear gap, so as to achieve an inaccurate positioning effect.

To achieve the aforementioned and other objectives, the present invention provides a rotary-shaft type turntable positioning method of an injection molding machine, used for controlling a turntable that is mounted to a rotary shaft in a movable mold base to be rotated to and positioned at a target position for performing injection molding, comprising the steps of: (1) a central control unit presetting a specific value and a target value; (2) the central control unit inputting the specific value; (3) a driving shaft of a servomotor being rotated according to the specific valve; (4) a first encoder sensing a first rotation signal of the driving shaft and transmitting the first rotation signal to the central control unit; (5) the driving shaft driving an output shaft of a speed reducer to rotate; (6) the output shaft driving a rotary shaft for rotating the turntable; (7) a second encoder sensing a second rotation signal of the output shaft and transmitting the second rotation signal to the central control unit; (8) the central control unit comparing the second rotation signal with the target value and confirming whether the second rotation signal meets the target value or not; (9) when the second rotation signal does not meet the target value, the central control unit calculating a compensation value according to an error value; (10) the central control unit inputting the compensation value; (11) the driving shaft of the sevomotor being rotated according to the compensation value, and returning to step S4; (12) when the second rotation signal meets the target value, the output shaft driving the rotary shaft for the turntable to be rotated to and positioned at the target position; and (13) performing an injection molding.

Based on the aforementioned structure, the rotary-shaft type turntable positioning device of the present invention uses the displacement driving mechanism to control the turntable mounted to the rotary shaft to move forward or retract for the operation of engaging or opening the male and female molds. After the first injection molding is completed, the servomotor drives the output shaft of the speed reducer to rotate the driving wheel, and the transmission belt drives the rotary shaft to rotate and position the turntable simultaneously. During rotation, the first encoder installed at the servomotor and the second encoder installed at the speed reducer sense the rotation signals to adjust the speed and position feedback, so that the servomotor can rotate the turntable to a precise position to achieve a quick positioning effect.

### BRIEF DESCRIPTION OF THE DRAWINGS

FIG. 1 is a block diagram of an injection molding machine of the present invention;

FIG. 2 is a front view of an injection molding machine of the present invention;

FIG. 3 is a schematic view of a rotary shaft of an injection molding machine of the present invention, wherein the rotary shaft is pushed forward;

FIG. 4 is a flow chart of the present invention; and

FIG. 5 is a schematic view of a rotary shaft of an injection molding machine of the present invention, wherein the rotary shaft is retracted.

### DESCRIPTION OF THE PREFERRED EMBODIMENTS

The aforementioned and other objectives and advantages of the present invention will become clearer in light of the following detailed description of an illustrative embodiment of this invention described in connection with the drawings. It is intended that the embodiments and drawings disclosed herein are to be considered illustrative rather than restrictive.

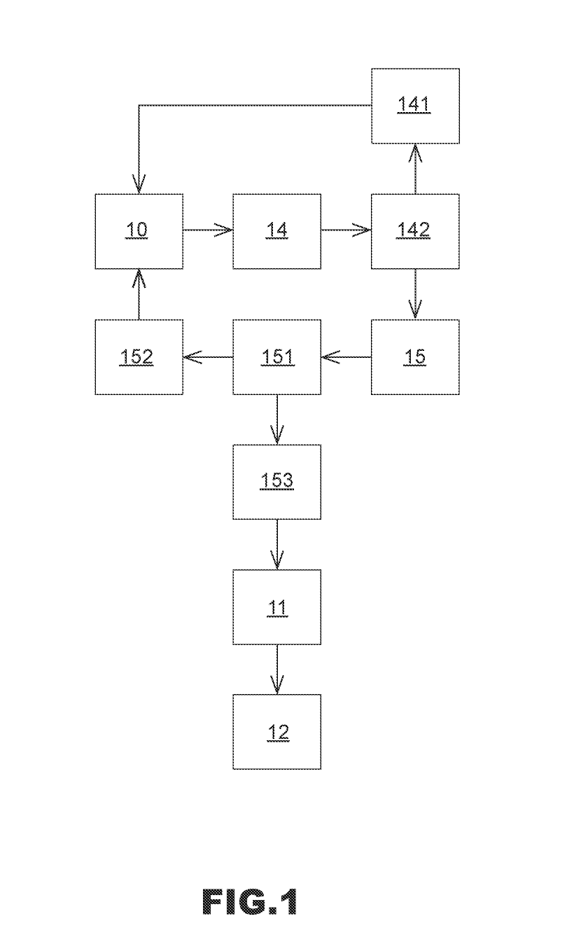

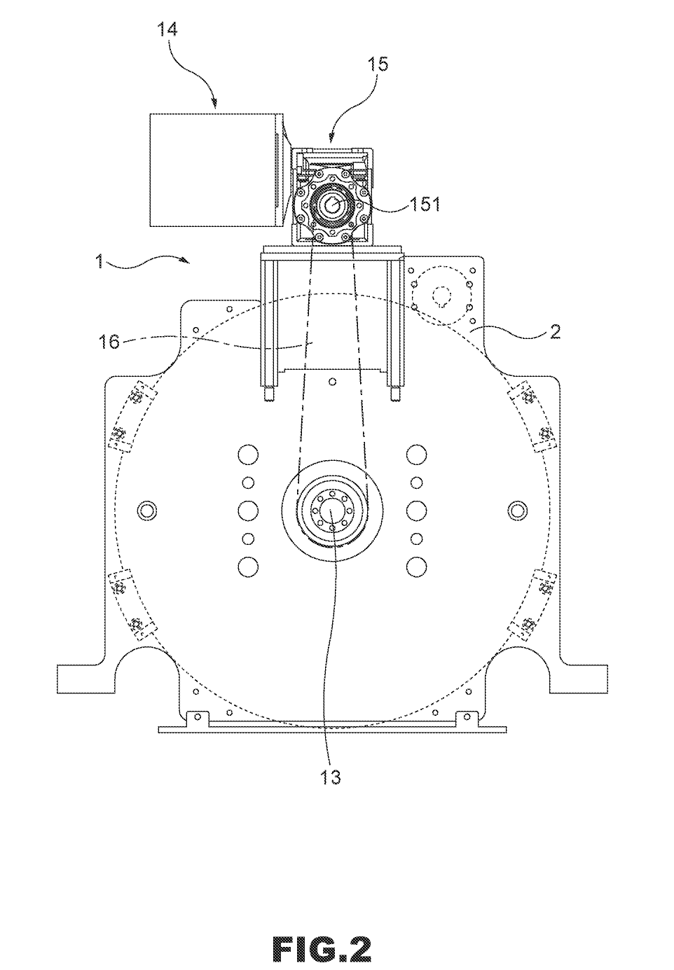

With reference to FIGS. 1 to 3 for an injection molding machine rotary shaft turntable positioning device of the present invention, the injection molding machine rotary shaft turntable positioning device 1 is installed at a movable mold base 2, and the movable mold base 2 includes a rotary shaft sleeve 3 installed therein, and the rotary shaft sleeve 3 has a driven wheel 31, and the positioning device 1 comprises a rotary shaft 11, a displacement driving mechanism 13, a servomotor 14, a speed reducer 15, a central control unit 10 and a transmission belt 16. The rotary shaft 11 is installed in the rotary shaft sleeve 3, and a turntable 12 is installed at an end of the rotary shaft 11. The displacement driving mechanism 13 is installed at an end of the rotary shaft 11 without the turntable 12 and provided for driving the rotary shaft 11 to move horizontally. The servomotor 14 has a driving shaft 142. The driving shaft 142 is provided with a first encoder 141. The speed reducer 15 is installed at the servomotor 14 and has a reduction gear 150 driven by the driving shaft 142, and the reduction gear 150 has an output shaft 151, and the output shaft 151 has a second encoder 152 and a driving wheel 153.

The central control unit 10 transmits a signal to the servomotor 14 according to a specified value and a target value and receives the sensed signal fed back from the first encoder 141 and the second encoder 152. The transmission belt 16 is looped over the driving wheel 153 and the driven wheel 31 of the rotary shaft sleeve 3.

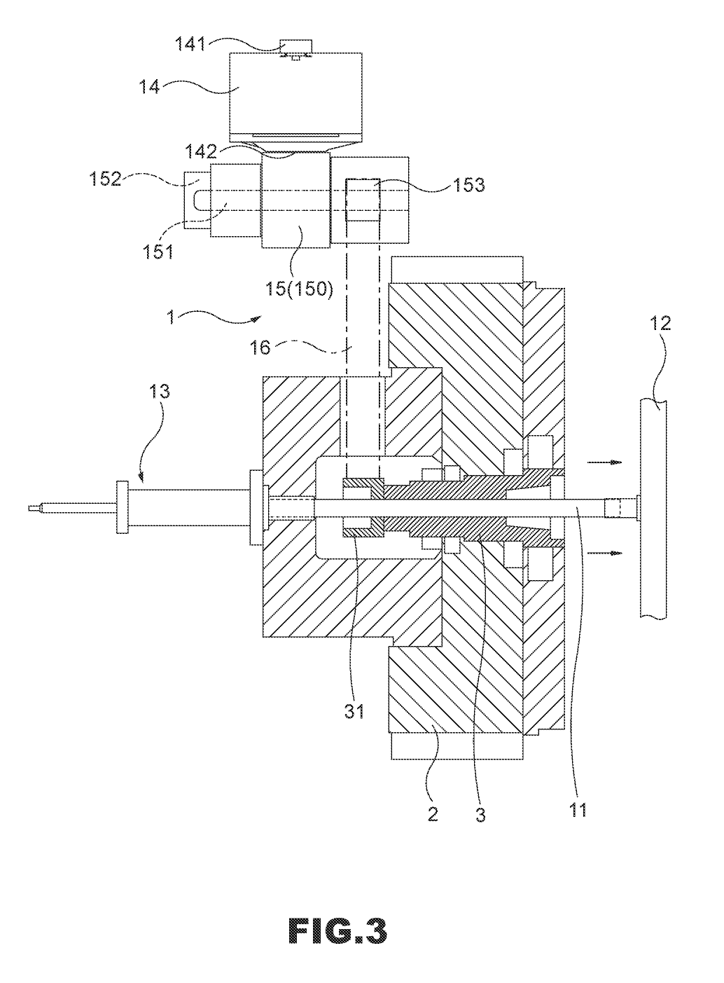

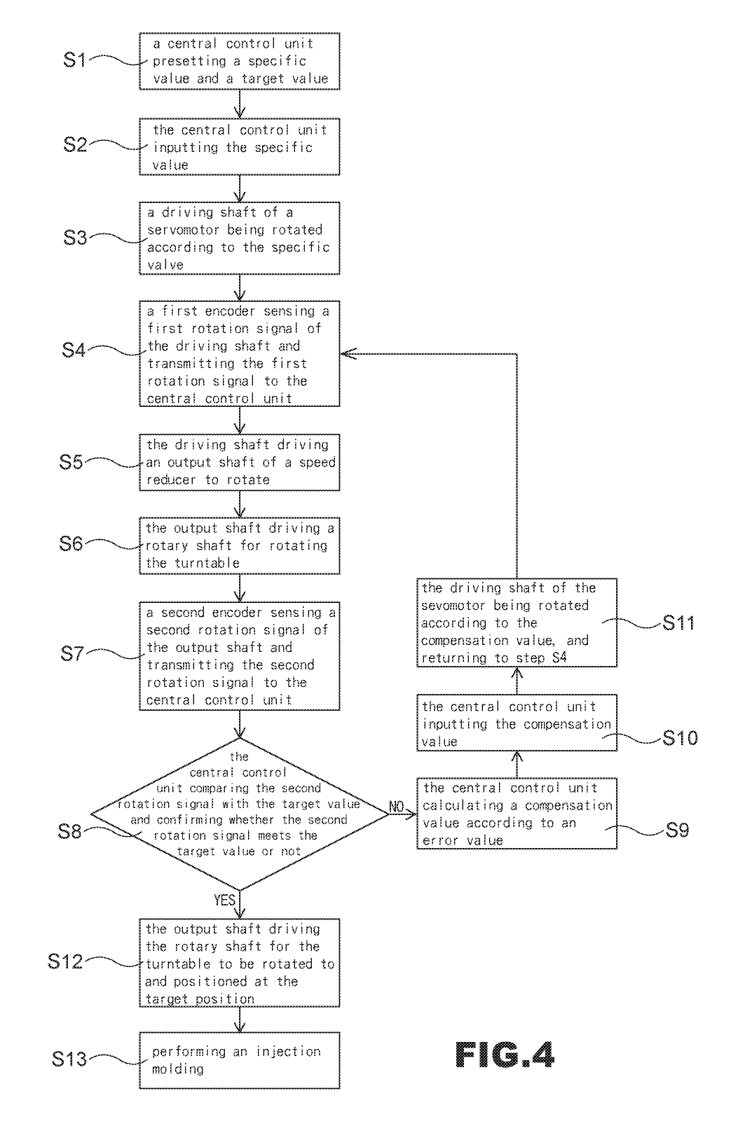

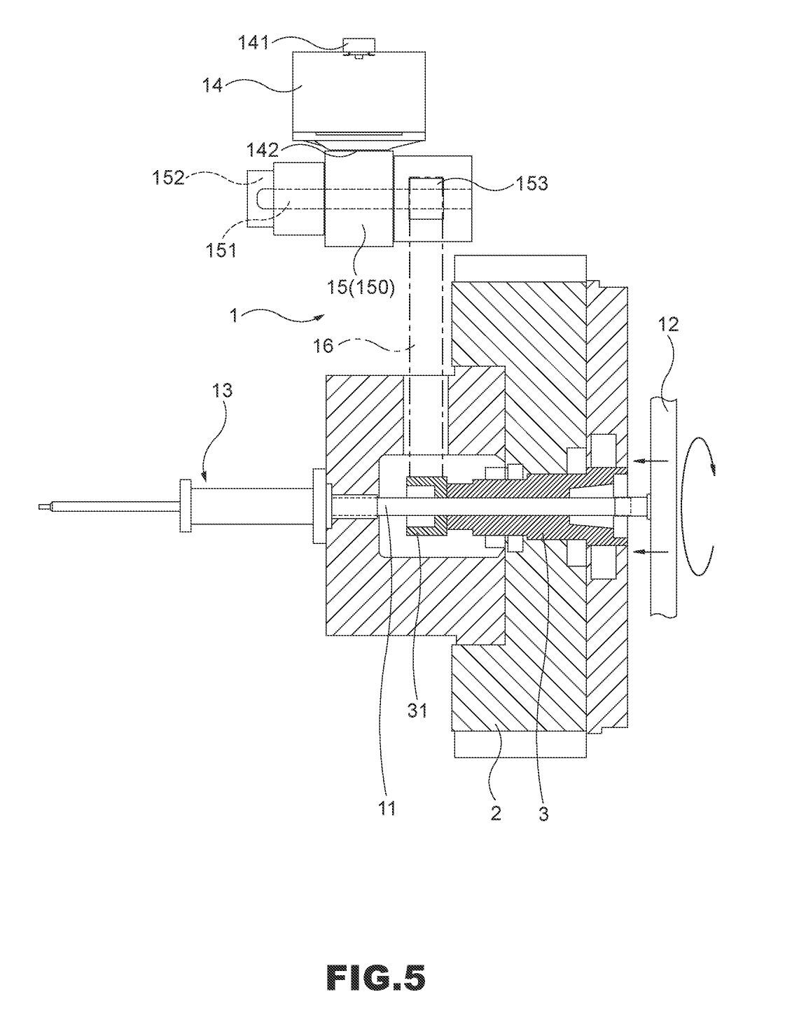

As shown in FIG. 3, when the injection molding machine adopts a rotary-shaft type turntable, the male mold is mounted onto the turntable 12, and the displacement driving mechanism 13 is operated to push the turntable 12 until the male mold is closely engaged with the female mold (as indicated by the arrow in FIG. 3). After the male and female molds are engaged, a first injection molding takes place. After the injection molding is completed, the displacement driving mechanism 13 is operated again to pull the turntable 12 back to its original position as shown in FIG. 4 and FIG. 5, so that the male mold is separated from the female mold. After the central control unit 10 presets a specific value and a target value of the speed and the position (the number of turns) (step S1), the central control unit 10 inputs an appropriate voltage command generated by the specific value (step S2) in order to rotate the driving shaft 142 of the servomotor 14 (step S3). The servomotor 14 is driven while the first encoder 141 senses a first rotation signal of the driving shaft 142 of the servomotor 14 and transmits the signal to the central control unit 10 (step S4), and the driving shaft 142 drives the output shaft 151 of the reduction gear 150 of the speed reducer 15 to rotate (step S5). The output shaft 151 drives the driving wheel 153 to rotate, and the driving wheel 153 drives the rotary shaft 11 to rotate through the transmission belt 16 for rotating the turntable 12 mounted to the rotary shaft 11(step S6). Simultaneously, the second encoder 152 senses a second rotation signal of the output shaft 151 of the speed reducer 15 and transmits the signal to the central control unit 10 (step S7). The central control unit 10 converts the pulse signal generated by the speed and position fed back from the second rotation signal into a position signal to compare with the position signal of the target value, thereby confirming whether the reduction gear 150 has an error due to the backlash (Step S8). When the second rotation signal does not meet the target value, the central control unit 10 calculates a compensation value according to the error value (step S9) and re-adjusts the command given to the servomotor 14 according to the compensation value (step S10), so that the driving shaft 142 of the sevomotor 14 is rotated according to the command of the compensation value, and returns to step S4 (step S11). When the central control unit 10 receives the position signal of the second rotation signal of the second encoder 152 that meets the target value, the output shaft 151 drives the driving wheel 153 to rotate, and the driving wheel 153 drives the rotary shaft 11 to rotate through the transmission belt 16. The turntable 12 mounted to the rotary shaft 11 is rotated to and positioned at a target position (step S12), and then the displacement driving mechanism 13 pulls the rotary shaft 11 back again, and then the male and female molds are engaged with each other for performing a second injection molding (step S13).

By the first encoder 141 and the second encoder 152 installed at the servomotor 14 and the speed reducer 15 respectively, the first rotation signal and the second rotation signal transmitted from the first encoder 141 and the second encoder 152 to the central control unit 10 may be used to confirm whether or not there is an error occurred when the driving shaft 142 of the servomotor 14 drives the speed reducer 15. After the error is corrected, the command of the compensation value is transmitted to the servomotor 14 for controlling the driving shaft 142 to drive the speed reducer 15 and the driving wheel 153 to rotate, so as to position the rotary shaft 11 precisely.

The positioning method of the rotary-shaft type turntable 12 is used to control the turntable 12 that is mounted to the rotary shaft 11 in the movable mold base 2 to be rotated and positioned at the target position for performing an injection molding. It can be applied to the injection molding of two or more colors or materials in cooperation with the positioning method of the present invention by changing the specific value and the target value, so that the turntable 12 can be accurately positioned at each target position regardless of forward rotation or reverse rotation.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A rotary-shaft type turntable positioning method of an injection molding machine, used for controlling a turntable that is mounted to a rotary shaft in a movable mold base to be rotated to and positioned at at least two target positions for performing injection molding, comprising the steps of:
(1) a central control unit presetting a specific value and a target value;
(2) the central control unit inputting the specific value;
(3) a driving shaft of a servomotor being rotated according to the specific valve;
(4) a first encoder sensing a first rotation signal of the driving shaft and transmitting the first rotation signal to the central control unit;
(5) the driving shaft driving an output shaft of a speed reducer to rotate;
(6) the output shaft driving a rotary shaft for rotating the turntable;
(7) a second encoder sensing a second rotation signal of the output shaft and transmitting the second rotation signal to the central control unit;
(8) the central control unit comparing the second rotation signal with the target value and confirming whether the second rotation signal meets the target value or not;
(9) when the second rotation signal does not meet the target value, the central control unit calculating a compensation value according to an error value;
(10) the central control unit inputting the compensation value;
(11) the driving shaft of the sevomotor being rotated according to the compensation value, and returning to step S4;
(12) when the second rotation signal meets the target value, the output shaft driving the rotary shaft for the turntable to be rotated to and positioned at one of the at least two target positions; and
(13) performing an injection molding.

2. The rotary-shaft type turntable positioning method of the injection molding machine as claimed in claim 1, wherein the first encoder and the second encoder are rotary encoders.
